(19) United States
(12) Patent Application Publication
(10) Pub. No.: US 2026/0124029 A1
(43) Pub. Date: May 7, 2026

(54) Dental Shade Guide With Plurality of Shade Tabs and Built-In Light Source

(71) Applicant: B & D Dental Corporation, West Valley City, UT (US)

(72) Inventor: Benjamin JUNG, West Valley City, UT (US)

(21) Appl. No.: 19/380,477

(22) Filed: Nov. 5, 2025

Related U.S. Application Data
(60) Provisional application No. 63/717,097, filed on Nov. 6, 2024.

(51) Int. Cl. A61C 19/10

(52) U.S. Cl. CPC A61C 19/10

(57) ABSTRACT

A dental shade guide comprises a housing with an array of strips carried by the housing. An array of shade samples is carried by the array of strips and extends from the housing. Each shade sample has a different shade corresponding to dental shades. A light source is carried by the housing and oriented to face rearwardly with respect to the housing. A power source is carried by the housing and electrically coupled to the light source.

### PRIORITY CLAIM AND RELATED APPLICATIONS

Priority is claimed to US Provisional Patent Application No. 63/717,097, filed November 6, 2024, which is hereby incorporated herein by reference.

### BACKGROUND OF THE INVENTION

### Field of the Invention

This invention relates to a dental shade guide; and more particularly relates to a dental shade guide with a light source to determine a color of a tooth in a mouth of a patient to enable creating a dental restoration.

### Description of the Related Art

In the dental industry, shade guides have been used since 1939 when they were created by the VITA company in Germany. When dentists create restorations, they generally categorize human tooth colors into the A, B, C, and D color groups. These are further divided into approximately 16 shade tabs, allowing dentists to find the shade that closely matches the patient's teeth in order to place an order for the color with the dental laboratory for the restoration.

### BRIEF DESCRIPTIONS OF THE DRAWINGS

With the above and other related objectives in view, the invention consists in the details of construction and combination of parts, as will be more fully understood from the following description, when read in conjunction with the accompanying drawings in which:

FIG. 1a is a schematic diagram illustrating a method for determining a shade of a patient’s teeth using existing shade guides.

FIG. 1b is a schematic diagram illustrating a method for determining a shade of a patient’s teeth using a shade guide, according to an embodiment of the present invention.

FIG. 2a is a front perspective view of the shade guide equipped with shade tabs, according to an embodiment of the present invention.

FIG. 2b is a front view of the shade tabs of the shade guide of FIG. 2a.

FIG. 2c is a front view of the shade guide of FIG. 2a.

FIG. 3a is a rear perspective view of the shade guide of FIG. 2a.

FIG. 3b is a back view of the shade guide of FIG. 2a.

FIG. 4a is an exploded rear perspective view of the shade guide of FIG. 2a.

FIG. 4b is an exploded front perspective view of the shade guide of FIG. 2a.

### DETAILED DESCRIPTION OF THE EMBODIMENTS OF THE INVENTION

Illustrative embodiments of the present invention are described below. The following explanation provides specific details for a thorough understanding of and enabling description for these embodiments. One skilled in the art will understand that the invention may be practiced without such details. In some instances, well-known structures, processes, and functions have not been shown or described in detail to avoid unnecessarily obscuring the description of the embodiments.

It shall be noted that unless the context clearly requires otherwise, throughout the description, the words “comprise,” “comprising,” “include,” “including,” and the like are to be construed in an inclusive sense as opposed to an exclusive or exhaustive sense; that is to say, in the sense of “including, but not limited to.” Words using the singular or plural number also include the plural or singular number, respectively while adhering to the concepts of the present invention. Furthermore, references to “one embodiment” and “an embodiment” are not intended to be interpreted as excluding the existence of additional embodiments that also incorporate the recited features.

The terms “interference fit” and “friction fit” are terms of art used interchangeably herein to refer to deliberately causing, increasing and/or using friction to deliberately resist movement. An interference fit or friction fit is different than and great than the existence of friction. While friction may exist between any two surfaces, is often desirable to do all one can to reduce this friction. An interference fit or friction fit can be distinguished from naturally occurring friction by being actually deliberately caused and increased. An interference fit can be created by dimensioning engaging parts so that their surfaces tightly bear against one another. A friction fit can be created by surface roughness that is rougher.

The term “ferromagnetic” is used herein to refer to a material or element that has magnetic properties and/or an ability to magnetically couple, either by being magnetic, or being magnetically attracted to a magnet (such as by containing iron) such that one ferromagnetic material or element is magnetically attracted to another ferromagnetic material or element. Thus, a ferromagnetic element is a magnet or is magnetic, such as a permanent magnet, or is attracted to magnets, such as by containing iron. The term ferromagnetic and magnetic element is intended to include a neodymium magnet.

In the dental industry, shade guides are used by dentists to create dental restorations by generally categorizing human tooth colors into the A, B, C, and D color groups. These are further divided into approximately 16 shades, allowing dentists to find the shade that closely matches the patient's teeth in order to place an order for the color with the dental laboratory for the restoration.

There are several constraints when determining these shades. Among them, the two biggest constraints can be: 1) the lighting conditions in the dental office when deciding on the color may differ from the lighting conditions in the dental lab, which can lead to discrepancies between the color of the restoration and the actual color of the patient's teeth; and 2) if the materials of the shades differ from the materials used for the restoration, it may be difficult to reproduce the color accurately.

Color can be a result of how the human eye perceives the components of color based on the reflection of light. When the light source differs, different colors can be perceived by the human eye; and this becomes especially important when distinguishing subtle differences, such as those found in human teeth. Furthermore, even with the same light source, the brightness of that light source -- essentially the amount of light emitted – can determine what is generally refer to as the hue.

Generally, dentists can use LED light sources when determining the color of a patient's teeth because LED lights provide consistent color results enabling accurate shade matching. Overall, LED light sources can provide dentists with better color accuracy, comfort, and efficacy when taking tooth shades. By using LED lighting, dental professionals can enhance their ability to provide aesthetically pleasing results in restorative dentistry, improving patient satisfaction and outcomes.

Specifically, LED lights can provide a stable color temperature, typically between 4,500K and 5,500K, which closely resembles natural daylight. This consistency helps in accurately assessing the true color of natural teeth, making it easier to match dental materials to the shade of a patient’s teeth. Also, LEDs typically have a high CRI (Color Rendering Index, 90 or above), which means they render colors more accurately compared to other light sources. This can be useful in dentistry where precise shade matching can be useful for aesthetic restorations.

Also, the LED light source can be designed to minimize shadows during shade assessments. This uniform light distribution can help dentists to view the full color of the tooth without interference from shadows, allowing for a more accurate evaluation. LEDs can emit significantly less heat compared to traditional light sources like incandescent or halogen lights. This not only provides comfort for the patient during the procedure but also allows the dentist to focus on the shade-taking process without the concern of overheating the surrounding tissues.

Color temperature is a measure that describes the appearance of light emitted by a light source, typically expressed in Kelvin (K). It refers to the hue or tone of the light, ranging from warm (reddish/yellowish) to cool (bluish/white) light. Color temperature is based on the concept of how an ideal black body radiator emits light as it heats up, moving from red to white to blue.

The Kelvin scale can be in 3 different zones: 1) lower temperatures (2,700K – 3,500K) called warm colors and have a yellowish or reddish hue, similar to incandescent bulbs or sunset lighting; 2) mid-range temperatures (3,500K – 5,500K) that are more neutral, resembling natural daylight around midday, and often used for task lighting or color matching; and 3) higher temperatures (5,500K – 10,000K) called cool or daylight colors and have a bluish hue. Light above 6,500K looks very blue and is often used for precise work environments such as laboratories. Color temperature can be a useful consideration in lighting design, impacting how we perceive spaces, colors, and objects.

The most reliable light source for dental color selection can be one that closely mimics natural daylight, typically within the range of 5,000 to 6,500 Kelvin on the color temperature scale. This range can be referred to as D65 lighting, which represents the standard for natural daylight and can provide the most accurate representation of dental materials and tooth shades.

When the color temperature is at a low level between 1000K and 4000K, it typically appears orange or yellow. On the other hand, when the color temperature exceeds 7000K, it takes on a blue hue, which can create issues in accurately determining the color of the teeth.

Many dentists and labs use standardized daylight lamps or specific dental color-matching lamps, such as the VITA Easyshade or Rite-Lite 2. These devices are designed specifically for dental color selection and provide consistent, reliable lighting that simulates daylight.

Also, minimizing environmental factors can be considered. It may be useful to control ambient lighting conditions in the room where color matching is performed. Avoiding direct sunlight, overly warm (yellow) lighting, or overly cool (blue) lighting, can also be useful as these can distort the perception of color.

Dentists have determined the color of a patient’s teeth using shade tabs in dental offices that utilize various light sources. The present invention provides a shade guide with a light source. Having an LED light source attached to the shade guide can be helpful in accurately determining the color of the teeth.

Two methods for a dentist to determine a patient's tooth color can be as follows. A first method can involve holding the shade guide as close as possible to the patient's tooth and selecting the most similar shade tab from the various options attached to the guide. A second method requires the dentist to select the shade tab they believe is the closest match from the shade guide, remove the chosen shade tab from the guide, and compare it to the patient's teeth. If they find it to be different, the dentist repeatedly selects the next closest shade tab for comparison. If these processes are carried out using different light sources with varying color temperatures and in different rooms by different dentists, achieving consistency with the laboratory fabricating the restoration can be difficult. A useful element in this process is when a specific shade tab is selected and brought close to the patient's teeth for comparison. There can be sufficient light provided using the shade guide with a light source attached to the shade guide and in close proximity, as described herein.

Having the light source as close as possible to the shade guide can be useful. The reasons for this include: 1) the human teeth are located inside the mouth; 2) the teeth are particularly covered by the lips, which can obstruct the ability to accurately perceive their color; and 3) the shadows created by the lips present constant challenges when trying to catch the correct color. One method to reduce these limitations is to attach the light source as close as possible to the shade guide, which can minimize shadows and can ensure an adequate amount of natural light. This can also make it easier to produce restorations that closely match the patient's original natural teeth color.

More specifically, when comparing a dental shade tab against a patient’s natural tooth using a 5000 Kelvin LED light source (which simulates daylight), the ideal distance between the light source and the patient's teeth can be about 10 to 16 inches (25 to 40 cm). This distance can allow for accurate illumination without causing excessive brightness or shadows that can distort color perception. At this distance, the light can be evenly distributed across the tooth surface and the shade tab, reducing glare or uneven lighting. 5,000K-6,500K closely resembles natural daylight, which can be useful for accurate color matching in dentistry. The light source can be positioned to avoid shadows, which can alter the perception of the tooth’s true color. The dentist or technician can view the tooth and shade tab from a perpendicular angle (90°) to avoid reflection and glare that can occur at steeper angles.

For this reason, when selecting and comparing the closest shade tab, having the light source integrated into a back housing of the shade guide allows for a sufficient amount of light to directly illuminate the teeth while minimizing shadows. This can be useful in helping the dentist accurately determine the color needed for the patient's restoration.

Some shade tabs used in the market are made from composite resin. However, restorations are not made from composite resins but are made predominately out of zirconia. The refractive index of zirconia and the refractive index of composite resin can differ significantly. The shade tabs of the present shade guide can be made from the same material as the subsequent dental restoration.

The refractive index (RI) of a material is a measure of how much light bends, or refracts, as it passes through that material. It is defined as the ratio of the speed of light in a vacuum to the speed of light in the material. A higher refractive index indicates that light travels slower through the material and bends more.

Composite materials, commonly used in dental fillings and restorations, can have a refractive index in the range of 1.50 to 1.55. While composites can mimic the natural tooth to some extent, they tend to be less translucent than natural enamel and more opaque.

Zirconia, can have strength and durability, and can have a refractive index of 2.1 to 2.2, which is much higher than natural teeth. While zirconia provides excellent mechanical properties, its high refractive index makes it more opaque, meaning it lacks the natural translucency of human teeth.

With the present shade guide and integrated light source, it becomes possible for more dentists to use the same light source and the same color temperature. Use of the present shade guide allows dental laboratories to produce restorations in the desired color with more consistent results. As described above, if the light source changes, the same shade tab or restoration may visually appear different. Evaluations of a person's teeth or restorations can vary based on factors such as bright or dim lighting, whether it is natural light or fluorescent light, and whether viewed by younger or older eyes.

The term “built-in” means that the light source can be either a fixed component integrated into shade guide or a separate piece that can be attached and detached from the shade guide, allowing for a shade guide that enables the light source to be removed and reattached.

The Kelvin temperature of the light source can range from 4500K to 5500K. Additionally, the CRI (Color Rendering Index) can be 90 or higher. One end of the shade guide can have a USB-C type connector for charging a battery. The battery and light source can operate at 3V.

The shade guide can have a housing with shade tabs. Shade tabs can feature a simplified restoration attached to a metal holder. This restoration can generally represent the shape of an anterior tooth, and can be made from materials such as composite resin, porcelain, or zirconia. The metal holder can indicate the colors of different teeth. The shade tabs can be inserted into the housing of the shade guide.

A power button can allow the shade guide to be turned on and off. A Kelvin adjustment button can enable adjustment of the color temperature mentioned earlier. Color temperature can be generally indicated in Kelvin or K, with dental applications typically using between 5,000K and 6500K. However, this range applies to situations where the light source is generally about 3 to 5 feet away from the patient. In the case of the present invention, where the light is emitted very close to the teeth, 4500K may be a more realistic color temperature for discerning natural teeth.

If the Kelvin value is excessively high, the light may become too intense and wash out the color of the teeth, whereas if it is excessively low, a yellowish hue may occur. The light source can emit light. The light source can comprise LED(s). The light can be projected through a light channel.

The shade tabs can be designed to fit into the top cover, and these shade tabs can be snugly engaged by the middle cover. An integrated circuit panel, e.g. a printed circuit board (PCB), can carry the light source, as well as the power button and the Kelvin adjustment button, which allows for the adjustment of the Kelvin temperature. Additionally, a rechargeable battery can be charged through a power port. The bottom cover serves to protect all these parts from underneath.

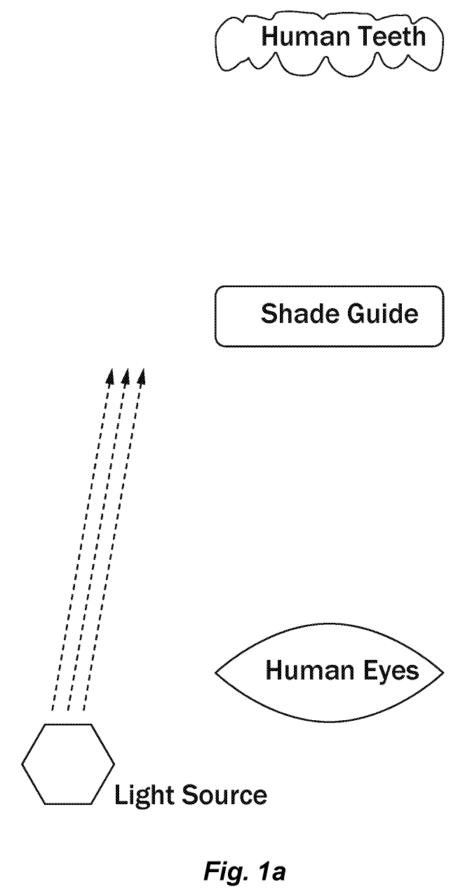

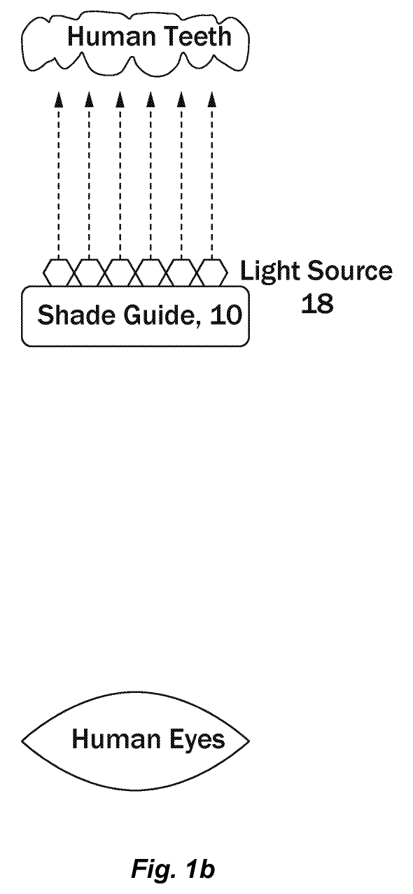

As shown in FIG. 1a, a conventional method can involve dentists using various types of light sources in the dental office to determine the color of the patient's teeth, and these light sources can be positioned far from the patient's teeth. Therefore, there may be instances where insufficient light is directed onto the patient's teeth, and adjusting the desired angle of the light source might not be practical. Additionally, it can be challenging to easily avoid shadows cast on the patient's teeth by different objects.

In contrast, as shown in FIG. 1b, when using the present shade guide 10 with an integrated light source 18, the light source is directly attached to the shade guide held by the dentist. This offers at least two advantages: 1) the desired light source (e.g. a light emitting diode (LED)) can be projected directly and close to the teeth; and 2) by moving the shade guide with one hand, the angle of the light can be easily adjusted while simultaneously controlling shadows, such as those cast by the patient's lips, with the other hand.

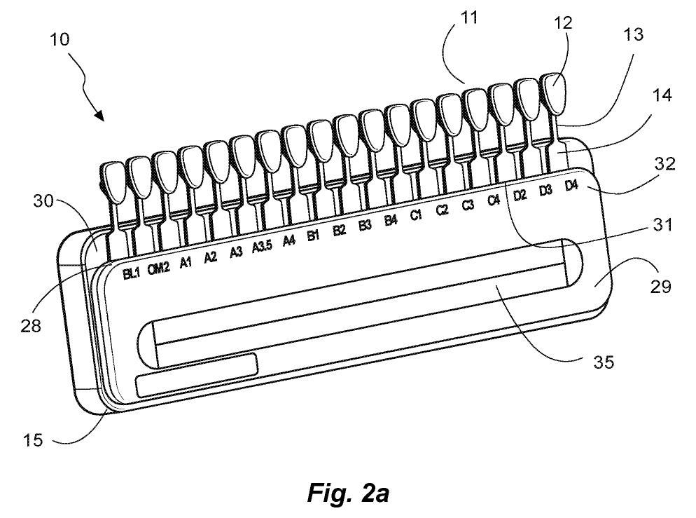

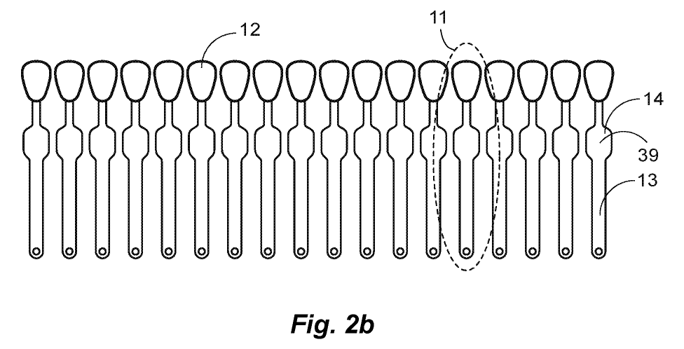

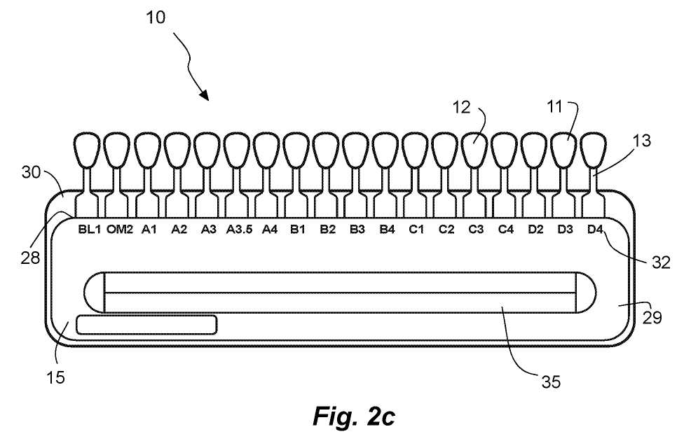

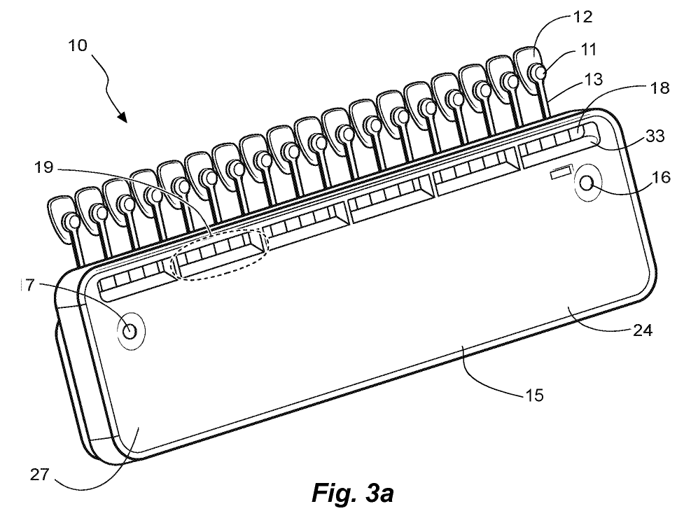

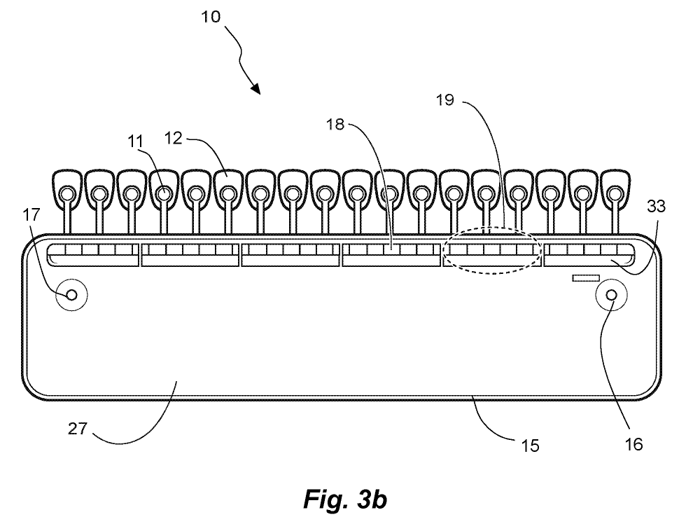

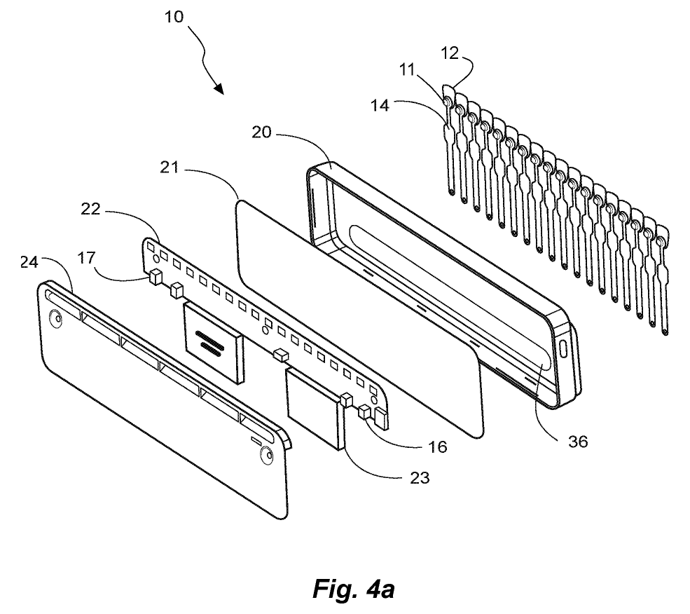

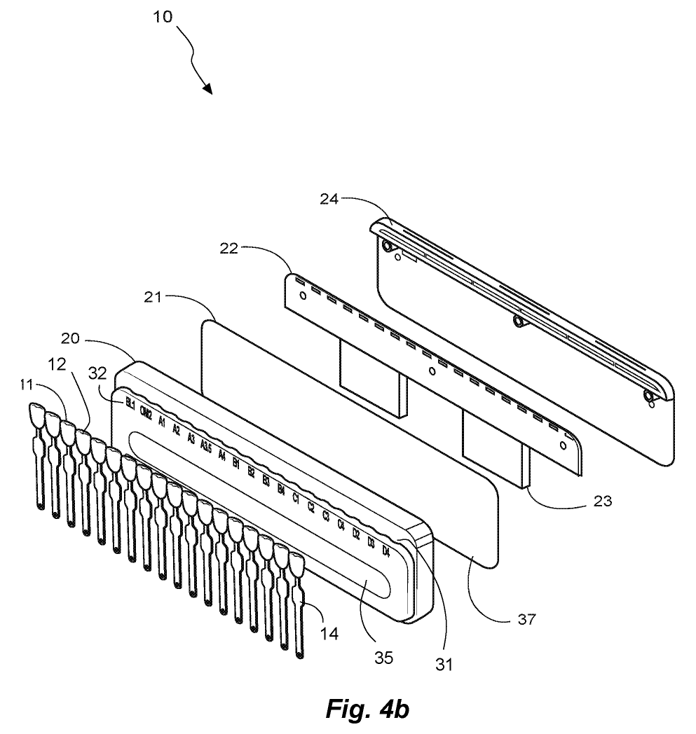

Referring to FIGS. 2a-4b, an example of a dental shade guide 10 is shown to determine a color of a tooth in a mouth of a patient to enable creating a restoration, according to an embodiment. The guide 10 can have a housing 15 with a back to face rearwardly towards a patient or a patient’s teeth, and a front to face forwardly to the user. The housing 15 can have a back wall 27 (of a bottom cover 24) and a front step 28 with a front wall 29 and an intermediate wall 30 between the front wall 29 and the back wall 27 (of a top cover 20). The front step 28 can be intermediate a top and a bottom of the housing 15. An interior wall 21 (FIGS. 4a and 4b) can be located in the housing 15 between the back wall 27 and the front wall 29. An elongated window opening 19 or light channel can be formed in the back wall 27 of the housing 15. An array of slots 31 can be formed in the front step 28 of the housing 15. The housing 15 can include a top cover 20 and a bottom cover 24. The housing 15 can be formed of plastic and can be formed by injection molding.

An array of indicia 32 can be on the front wall (or the top cover 20) with each indicium associated with a different slot of the array of slots 31 and each indicium indicating a different shade (e.g. BL1, OM2, A1, A2, A3, A3.5, B1, B2, B3, B4, C1, C2, C3, C4, D2, D3, and D4) corresponding to dental shades. The indicia 32 can be molded into the front wall 29, printed on the front wall, or printed on stickers applied to the front wall.

An array of shade tabs 11 can be carried by the housing 15. The shade tabs 11 can comprise an array of strips 13 that can be carried by the housing 15 and associated with the array of slots 31. The shade tabs 11 and the strips 13 can be removably carried by the housing 15. Each strip of the array of strips 13 can have a proximal end removably received in a different slot of the array of slots 31. The proximal end of each strip of the array of strips 13 can have an interference fit between the interior wall 21 and the front wall 29 (of the top cover 20). An elongated indentation 35 can be formed in the front wall 29 of the top cover 20 of the housing 15 corresponding to an elongated protrusion 36 inside the housing 15. The indentation 35 can form a grip. At least one protrusion 37 (FIG. 4b) can extend from the interior wall 21 in the housing 15 and can correspond to the elongated protrusion 36 of the front wall 29 to form the interference fit therebetween with the proximal ends of the array of strips 11. In another aspect, the shade tabs 11, the strips 13 and the proximal ends can be magnetically retained in the housing by ferromagnetic elements on the proximal ends and one or more ferromagnetic elements in the housing.

An array of shade samples 12 or restoration samples can be carried by the housing 15 and can extend from the housing 15. The array of shade samples 12 can be carried by the array of strips 13 and can extend from the housing 15. The array of shade samples 12 can be oriented to face forwardly with respect to the housing 15. Each shade sample 12 can have a different shade corresponding to dental shades (e.g. BL1, OM2, A1, A2, A3, A3.5, B1, B2, B3, B4, C1, C2, C3, C4, D2, D3, and D4) and that can correspond to an indicium 32 indicating a shade of the shade sample 12. Each shade sample 12 can comprise a dental material comprising one or more of resin, porcelain or zirconia that can correspond to a dental material of the dental restoration to be made. Each shade sample 12 can have a shape of an anterior tooth. The material and/or shape of the shade samples 12 can assist in determining a shade of a patient’s tooth.

An array of tabs 14 can be associated with the array of strips 13 and can be positioned below the array of shade samples 12. An array of indicia 39 can be carried on the array of tabs 14 corresponding to the array of shade samples 12 and matching the array of indicia 32 on the front wall 29 of the housing 15. The indicia 39 can include symbols indicative of the shade colors (e.g. BL1, OM2, A1, A2, A3, A3.5, B1, B2, B3, B4, C1, C2, C3, C4, D2, D3, and D4).

A light source 18 (e.g. LED(s)) can be carried by the housing 15 and oriented to face rearwardly with respect to the housing 15. The light source 18 can be positioned behind the array of shade samples 12. The light source 18 can comprise an array of light emitting diodes (LEDs) extending across a width of the array of shade samples 12 to provide adequate viewing. The light source 18 can be positioned in the housing 15 and can be aligned with the elongated window opening 19 in the back wall 27 of the bottom cover 24 and can be oriented to face rearwardly with respect to the housing 15. The elongated window opening 19 can have a bevel 33 in a bottom edge of the elongated window opening 19 to enable light from the light source 18 to reflect off the bevel 33 upwardly behind the array of shade samples 12.

A printed circuit board (PCB) 22 (FIGS. 4a and 4b) can be carried by the housing 15 and positioned in the housing 15. The light source 18 can be carried by the PCB 22. A power source 23, such as a rechargeable battery, can be positioned in the housing and electrically coupled to the light source 18, such as via the PCB 22. A power button 16 can be carried by the housing 15 and electrically coupled to the light source 18 and the power source 23, such as via the PCB 22. The power button 16 can be carried by the PCB 22 and accessible through an aperture in the housing 15. An adjustment button 17 can be carried by the housing 15 and electrically coupled to electronics (e.g. the PCB 22 and other electrical components and/or processors) in the housing 15 to enable adjustment of warmth of the light source 18. The adjustment button 17 can be carried by the PCB 22 and accessible through an aperture in the housing. A power port can be carried by the PCB 22 to charge the rechargeable battery.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

As used herein, the term processor can include general purpose processors, specialized processors such as VLSI, FPGAs, or other types of specialized processors, as well as baseband processors used in transceivers to send, receive, and process wireless communications.

It should be understood that some of the functional units described in this specification can be labeled as modules, in order to more particularly emphasize their implementation independence. For example, a module can be implemented as a hardware circuit comprising custom very-large-scale integration (VLSI) circuits or gate arrays, off-the-shelf semiconductors such as logic chips, transistors, or other discrete components. A module can also be implemented in programmable hardware devices such as field programmable gate arrays, programmable array logic, programmable logic devices or the like.

In one example, multiple hardware circuits or multiple processors can be used to implement the functional units described in this specification. For example, a first hardware circuit or a first processor can be used to perform processing operations and a second hardware circuit or a second processor (e.g., a transceiver or a baseband processor) can be used to communicate with other entities. The first hardware circuit and the second hardware circuit can be incorporated into a single hardware circuit, or alternatively, the first hardware circuit and the second hardware circuit can be separate hardware circuits.

Modules can also be implemented in software for execution by various types of processors. An identified module of executable code can, for instance, comprise one or more physical or logical blocks of computer instructions, which can, for instance, be organized as an object, procedure, or function. Nevertheless, the executables of an identified module need not be physically located together, but can comprise disparate instructions stored in different locations which, when joined logically together, comprise the module and achieve the stated purpose for the module.

Indeed, a module of executable code can be a single instruction, or many instructions, and can even be distributed over several different code segments, among different programs, and across several memory devices. Similarly, operational data can be identified and illustrated herein within modules, and can be embodied in any suitable form and organized within any suitable type of data structure. The operational data can be collected as a single data set, or can be distributed over different locations including over different storage devices, and can exist, at least partially, merely as electronic signals on a system or network. The modules can be passive or active, including agents operable to perform desired functions.

Reference throughout this specification to "an example" or “exemplary” means that a particular feature, structure, or characteristic described in connection with the example is included in at least one embodiment of the present invention. Thus, appearances of the phrases "in an example" or the word “exemplary” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention can be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics can be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A dental shade guide, comprising:
a housing;
an array of strips carried by the housing;
an array of shade samples carried by the array of strips and extending from the housing and oriented to face forwardly with respect to the housing, each shade sample having a different shade corresponding to dental shades;
a light source carried by the housing and oriented to face rearwardly with respect to the housing; and
a power source carried by the housing and electrically coupled to the light source.

2. The dental shade guide of claim 1, wherein the light source is positioned behind the array of shade samples.

3. The dental shade guide of claim 1, wherein the light source further comprises:
an array of light emitting diodes (LEDs) extending across a width of the array of shade samples.

4. The dental shade guide of claim 1, further comprising:
the housing having a window opening in a back wall of the housing; and
the light source positioned in the housing and aligned with the window opening.

5. The dental shade guide of claim 4, further comprising:
a power source positioned in the housing and electrically coupled to the light source;
a power button carried by the housing and electrically coupled to the light source and the power source; and
an adjustment button carried by the housing and electrically coupled to electronics in the housing to enable adjustment of warmth of the light source.

6. The dental shade guide of claim 1, wherein the array of strips is removably carried by the housing; and wherein a proximal end of each strip of the array of strips has an interference fit with the housing.

7. The dental shade guide of claim 1, further comprising:
an array of slots in the housing;
the array of strips associated with the array of slots; and
an array of indicia on the housing with each indicium associated with a different slot of the array of slots and each indicium associated with a different shade of the array of shade samples.

8. The dental shade guide of claim 7, further comprising:
an array of tabs associated with the array of strips and positioned below the array of shade samples; and
an array of indicia on the array of tabs corresponding to the array of shade samples and matching the array of indicia on the housing.

9. The dental shade guide of claim 1, wherein each shade sample comprises a dental material comprising one or more of resin, porcelain or zirconia.

10. The dental shade guide of claim 1, wherein each shade sample has a shape of an anterior tooth.

11. A dental shade guide configured to determine a color of a tooth in a mouth of a patient, comprising:
a housing having a back wall and a front step with a front wall and an intermediate wall between the front wall and the back wall, the front step being intermediate a top and a bottom of the housing;
an elongated window opening in the back wall of the housing;
an array of slots in the front step of the housing;
an array of indicia on the front wall with each indicium associated with a different slot of the array of slots and each indicium indicating a different shade;
an array of strips carried by the housing and associated with the array of slots;
each strip of the array of strips having a proximal end received in a different slot of the array of slots;
an array of shade samples carried by the array of strips and extending from the housing, each shade sample having a different shade and corresponding to an indicium indicating a shade of the shade sample;
a light source positioned in the housing and aligned with the elongated window opening in the back wall and oriented to face rearwardly with respect to the housing; and
a power source positioned in the housing and electrically coupled to the light source.

12. The dental shade guide of claim 11, wherein the light source further comprises:
an array of light emitting diodes (LEDs) extending across a width of the array of shade samples.

13. The dental shade guide of claim 11, wherein the array of strips is removably carried by the housing; and wherein a proximal end of each strip of the array of strips has an interference fit with the housing.

14. The dental shade guide of claim 11, further comprising:
an array of tabs associated with the array of strips and positioned below the array of shade samples; and
an array of indicia on the array of tabs corresponding to the array of shade samples and matching the array of indicia on the front wall of the housing.

15. The dental shade guide of claim 11, wherein each shade sample comprises a dental material comprising one or more of resin, porcelain or zirconia.

16. The dental shade guide of claim 11, wherein each shade sample has a shape of an anterior tooth.

17. The dental shade guide of claim 11, further comprising:
a power button carried by the housing and electrically coupled to the light source and the power source; and
an adjustment button carried by the housing and electrically coupled to electronics in the housing to enable adjustment of warmth of the light source.

18. A dental shade guide configured to determine a color of a tooth in a mouth of a patient to enable creating a restoration, comprising:
a housing having a back wall and a front step with a front wall and an intermediate wall between the front wall and the back wall, the front step being intermediate a top and a bottom of the housing;
an interior wall located in the housing between the back wall and the front wall;
an elongated window opening in the back wall of the housing;
an array of slots in the front step of the housing;
an array of indicia on the front wall with each indicium associated with a different slot of the array of slots and each indicium indicating a different shade;
an array of strips carried by the housing and associated with the array of slots;
each strip of the array of strips having a proximal end removably received in a different slot of the array of slots;
the proximal end of each strip of the array of strips having an interference fit between the interior wall and the front wall;
an array of shade samples carried by the array of strips and extending from the housing, each shade sample having a different shade and corresponding to an indicium indicating a shade of the shade sample;
each shade sample comprising a dental material comprising one or more of resin, porcelain or zirconia;
each shade sample having a shape of an anterior tooth;
an array of tabs associated with the array of strips and positioned below the array of shade samples;
an array of indicia on the array of tabs corresponding to the array of shade samples and matching the array of indicia on the front wall of the housing;
a light source positioned in the housing and aligned with the elongated window opening in the back wall and oriented to face rearwardly with respect to the housing;
a power source positioned in the housing and electrically coupled to the light source;
a power button carried by the housing and electrically coupled to the light source and the power source; and
an adjustment button carried by the housing and electrically coupled to electronics in the housing to enable adjustment of warmth of the light source.

19. The dental shade guide of claim 18, further comprising:
a bevel in a bottom edge of the elongated window opening configured to enable light from the light source to reflect off the bevel upwardly behind the array of shade samples.

20. The dental shade guide of claim 18, further comprising:
an elongated indentation in the front wall of the housing corresponding to an elongated protrusion inside the housing; and
at least one protrusion extending from the interior wall in the housing and corresponding to the elongated protrusion of the front wall to form the interference fit therebetween with the proximal ends of the array of strips.
